(19) United States
(12) Patent Application Publication
(10) Pub. No.: US 2026/0127487 A1
(43) Pub. Date: May 7, 2026

(54) System and method to dynamically detect anomalies in data exchange operations

(71) Applicant: Bank of America Corporation, Charlotte, NC (US)

(72) Inventors: Pratap Dande, Saint Johns, FL (US); Naga Vamsi Krishna Akkapeddi, Charlotte, NC (US)

(21) Appl. No.: 18/938,192

(22) Filed: Nov. 5, 2024

(51) Int. Cl. G06N 20/00; G06F 9/445

(52) U.S. Cl. CPC G06N 20/00; G06F 9/44505

(57) ABSTRACT

A system comprises a memory communicatively coupled to at least one processor. The at least one processor is configured to receive a request to perform a data exchange operation at a communication level and an evaluation level and determine multiple configuration parameters based on the data exchange operation and execute one or more machine learning algorithms to determine an operational path to complete the data exchange operation over a path duration based on the configuration parameters, assign a static token to the data exchange operation based on the communication level, assign a dynamic token to the data exchange operation based on the evaluation level, train a communication model to perform one or more sub-operations of the operational path using the static token, the dynamic token, and the configuration parameters, and perform one or more of the sub-operations in accordance with the communication model.

### TECHNICAL FIELD

The present disclosure relates generally to evaluating data exchange operations, and more specifically to a system and method to dynamically detect anomalies in data exchange operations.

### BACKGROUND

In communication systems, data exchanges between two devices may involve multiple services. For example, a request may be processed, routed, and/or forwarded by multiple services between a first device and a second device. As the data is exchanged, the services may be configured to modify one or more portions of initial data included in the request. For example, a request to access power resources in a power station may comprise encrypted credentials that a first service in a communication path decrypts prior to forwarding a decrypted version of the request to a second service. In this case, the initial data comprising encrypted portions is modified to comprise decrypted portions. As the services modify the initial data, the services may introduce errors into the data exchange. Following the previous example, the decrypted data may be decrypted using an incorrect decryption process. Herein, the entirety of the data exchange operation may be compromised if errors are introduced by one or more services.

### SUMMARY OF THE DISCLOSURE

In one or more embodiments, a system and method are configured to evaluate data exchange operations, and more specifically to dynamically detect anomalies in data exchange operations. In particular, the system may be configured to train a machine learning (ML) model to determine one or more anomalies and/or errors in processing performed by one or more services in one or more operational paths. In some embodiments, data exchanges between two or more devices may involve multiple services. For example, a request may be processed, routed, and/or forwarded by multiple services between a first device and a second device. As the data is sent from the first device to the second device, the services may be configured to modify one or more portions of the starting data included in the request. For example, a request to access communication resources in a base station may comprise signaling comprising a first format that a first service in the operational path may transform to a second format prior to forwarding a transformed version of the request to a second service. In this case, the starting data comprising the request in the first format is modified to comprise the second format. As the services modify the starting data, the system is configured to execute an ML algorithm to determine and address one or more anomalies introduced in the starting data. The services may be configured to inhibit, reduce, and/or eliminate anomalies and/or errors that may be introduced as part of modifications to the starting data. The system may be configured to train the ML model to determine preferred operational paths to complete one or more specific data exchange operations and evaluate inputs and/or outputs for every service along a specific operational path. The system may be configured to use one or more tokens referencing one or more aspects of the specific operational path, track possible modifications to the starting data as one or more services in the operational path modify the starting data, and correct any determined anomalies.

In some embodiments, the actions and/or operations may be evaluated by one or more ML algorithms in accordance with the ML models. The ML models may be trained to understand and/or predict operations associated with specific anomalies in a specific operational path. The system may be configured to provide data exchange operation anomaly detection as a service using reservoir computing, multi-level static and dynamic tokens generated in association with one or more decentralized networks and one or more models, and generative artificial intelligence. In this regard, the system may be configured to find the anomalies (e.g., errors and/or issues) in an operational path. Herein, the system may be configured to use reservoir computing to detect one or more suitable operational paths for a specific data exchange operation. The system may be configured to dynamically determine specific services as part of one or more operational paths based on one or more configuration parameters and/or historical data. In some embodiments, static tokens may be generated to represent one or more expected modifications (e.g., changes) to starting data over an entirety of a data exchange operation while dynamic tokens may be generated to represent one or more expected modifications to the starting data as one or more sub-operations of the data exchange operations are performed by one or more services. For example, the static tokens may represent changes in the starting data at a communication level while the dynamic tokens may represent changes in the starting data at an evaluation level (e.g., at every hop in the operational path). The ML algorithm may be configured to create rules for every hop to detect any data modifications and/or anomalies associated with the modifications.

In one or more embodiments, the system described herein are integrated into a practical application of improving security in a communication network by inhibiting, reducing, and/or eliminating anomalies in data exchange operations. In particular, the system is configured to preserve data integrity as one or more data exchange operations are performed between multiple devices. In this regard, the system is configured to determine whether services involved in a data exchange operation are responsible for introducing anomalies and/or errors in introduced after modifying starting data. The system may be configured to execute an ML algorithm to analyze inputs and outputs of data shared between two or more services in an operational path, determine tolerated possible changes to the starting data after each service modifies one or more aspects of the starting data, and determines one or more possible solutions to correct and/or remove the anomaly from future data exchange operations. Further, the system may be configured to inhibit, prevent, and/or eliminate anomalies in data exchange operations performed between two or more services. The system may execute the ML algorithm to determine potential changes to starting data as the starting data is modified by services along an operational path. Further, as the starting data is modified, the system may be configured to execute the ML algorithm to determine whether the modifications are within one or more tolerance ranges (e.g., thresholds). If the system determines that starting data is modified within a respective tolerance by a specific service, then the system may determine that the specific service introduced at least one anomaly. Further, the system is configured to increase security in data exchange operations as the system uses dynamic tokens and static tokens to securely monitor static and dynamic aspects of the data exchange operations. In this regard, the system is configured to securely evaluate changes to the starting data as each token is individually updated with modifications and/or changes to the starting data at each service.

In one or more embodiments, the system is directed to improvements in computer systems. Specifically, the system reduces processor and memory usage in servers and/or user devices by quickly determining anomalies introduced by services along an operational path comprising multiple services. As anomalies are determined in real-time as the data exchange operation is performed, the system is configured to dynamically generate alerts indicating whether the data exchange operation is being performed as intended. Herein, processing and memory usage is reduced because processing and memory resources are not consumed unnecessarily while continuing service operations using starting data comprising anomalies and/or errors. In some embodiments, the system does not allow data comprising anomalies to continue being used in data exchange operations. Instead, the system filters out anomalies and/or errors before a single data exchange operation is completed. Further, the system is configured to prevent resources from being wasted retrieving data and/or restoring sensitive information corrupted during data exchange operations. In this regard, the system inhibits possible adverse impacts that anomalies and/or errors could have caused in a communication network and/or as part of an operational path. As a result, workforce hours, processing resources, memory resources, and/or power resources are not spent retroactively tracking services and/or operations responsible for introducing anomalies and/or errors to the starting data.

In one or more embodiments, the system may comprise an apparatus, such as the server. Further, the system may be a data exchange system, that comprises the apparatus. In addition, the system may be configured to perform operations as part of a process performed by the apparatus. As a non-limiting example, the system may comprise a memory and at least one processor communicatively coupled to one another. The memory is operable to store one or more machine learning algorithms configured to perform one or more operations in accordance with one or more machine learning models. The at least one processor may be configured to receive a request to perform a data exchange operation at a communication level and an evaluation level and determine multiple configuration parameters based on the data exchange operation. The configuration parameters may comprise guidance to perform the data exchange operation. Further, the processor may be configured to execute the one or more machine learning algorithms to determine an operational path to complete the data exchange operation over a path duration based on the configuration parameters. The operational path may comprise multiple sub-operations to be performed over the path duration to complete the data exchange operation. The sub-operations may comprise a first sub-operation and a second sub-operation. The processor may be configured to execute the one or more machine learning to assign a static token to the data exchange operation based on the communication level, assign a dynamic token to the data exchange operation based on the evaluation level, and create multiple tolerances for one or more possible changes to starting data based on the communication level and the evaluation level. The dynamic token referencing the starting data to be modified by the sub-operations on the operational path over the path duration. The static token may reference the sub-operations to be performed on the operational path over the path duration. The tolerances may comprise a first tolerance corresponding to a first possible change to the starting data at the first sub-operation and a second tolerance corresponding to a second possible change to the starting data at the second sub-operation. The processor may be configured to train a communication model to perform the sub-operations of the operational path using the static token, the dynamic token, the tolerances, and the configuration parameters, and perform one or more of the sub-operations in accordance with the communication model.

Certain embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

### For a more complete understanding of this disclosure reference is now made to the following brief description taken in connection with the accompanying drawings and detailed description wherein like reference numerals represent like parts.

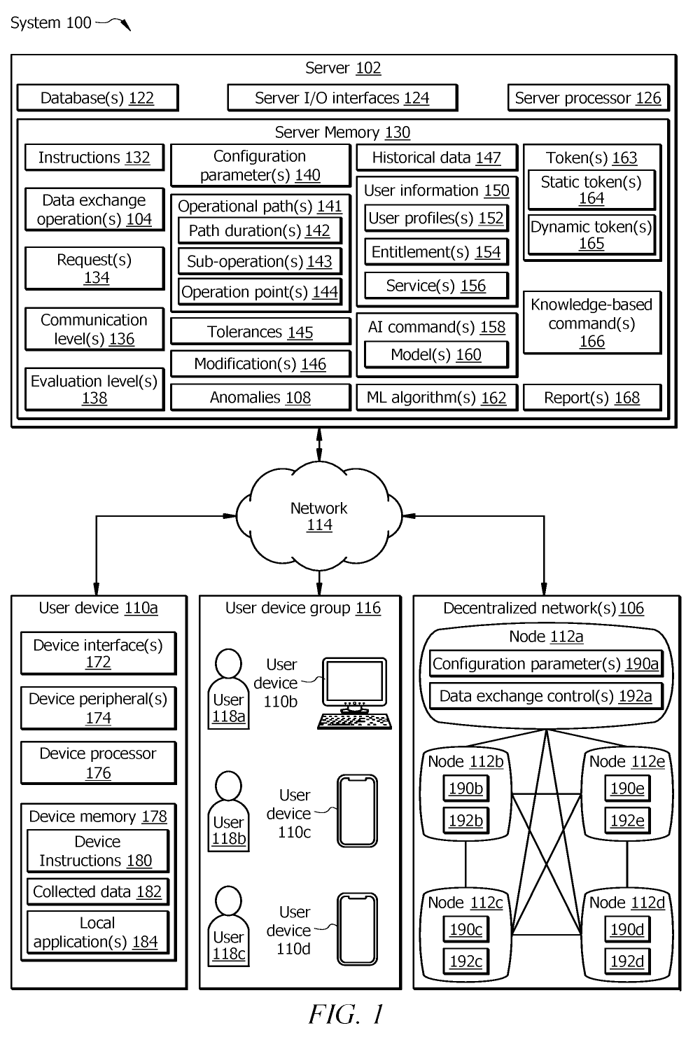

FIG. 1 illustrates a system in accordance with one or more embodiments;

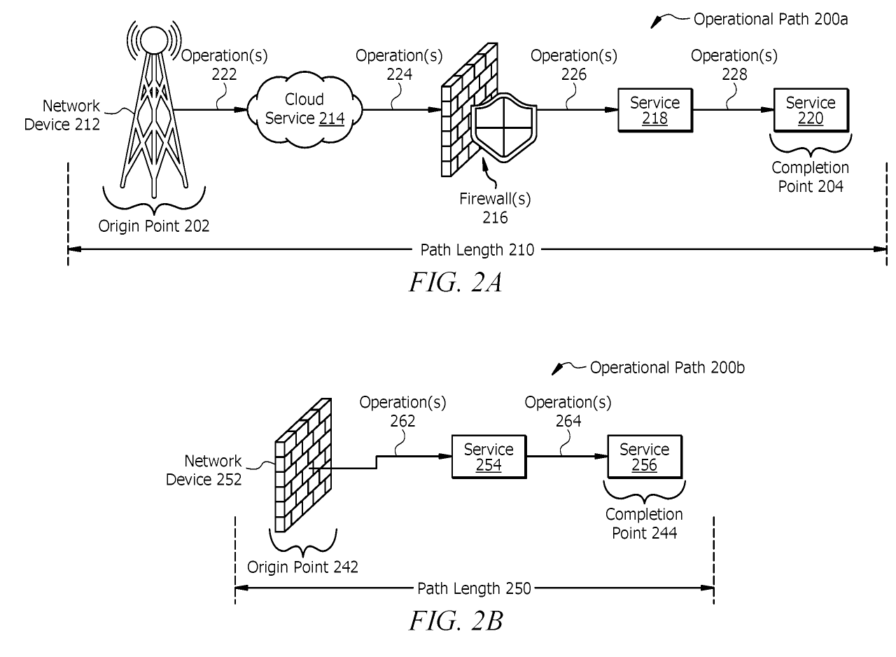

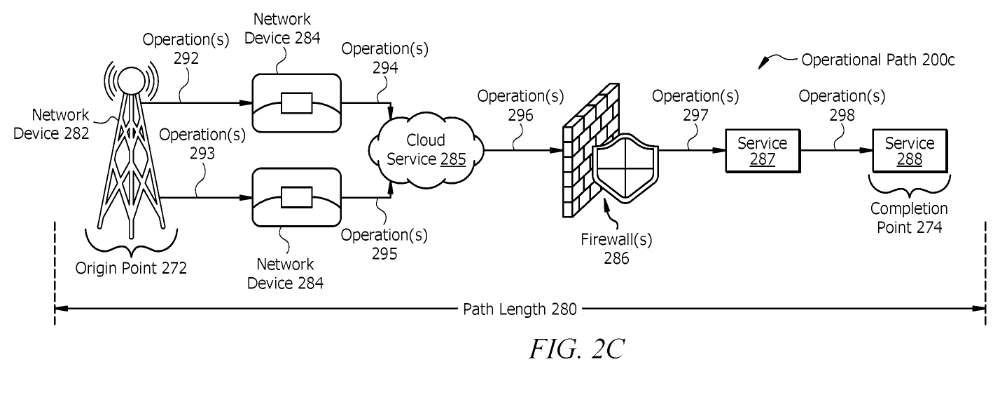

FIGS. 2A-2C illustrates multiple example operational paths performed in by the system of FIG. 1 in accordance with one or more embodiments; and

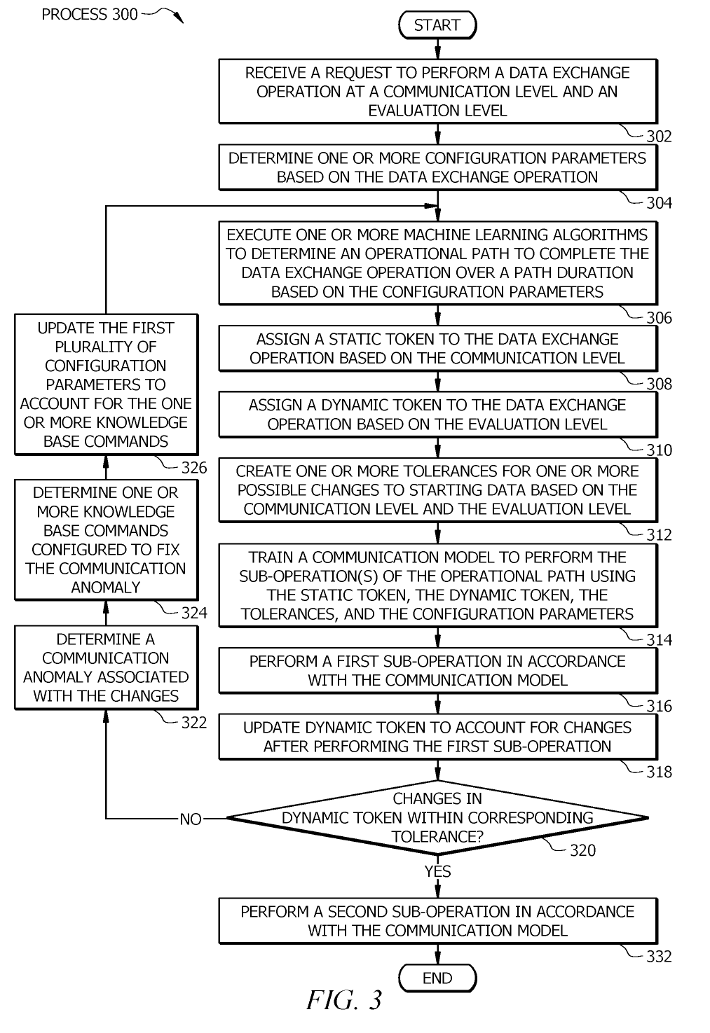

FIG. 3 illustrates an example flowchart of a method to performed by the system of FIG. 1 in accordance with one or more embodiments.

### DETAILED DESCRIPTION

As described above, this disclosure provides one or more systems and methods to dynamically detect errors as part of one or more operations performed between one or more sub-systems and/or electronic components. FIG. 1 illustrates a system 100 in which a server 102 performs one or more data exchange operations 104 in association with one or more decentralized networks 106. FIGS. 2A-2C illustrates multiple example operational paths 200a-200c to be performed by the system 100 of FIG. 1. FIG. 3 illustrates a process 300 performed by the system 100 of FIG. 1.

### System overview

FIG. 1 illustrates an example system 100, in accordance with one or more embodiments. The system 100 may comprise a server 102 configured to dynamically detect anomalies 108 in data exchange operations 104. The system 100 includes a server 102 communicatively coupled to a user device 110a, a user device 110b, a user device 110c, and a user device 110d (collectively user devices 110) and/or a node 112a, a node 112b, a node 112c, a node 112d, and a node 112e (collectively nodes 112) in the one or more decentralized networks 106 via a network 114. The user devices 110 may be working nodes configured to receive instructions to perform one or more data exchange operations 104 based on instructions received from the server 102. In some embodiments some of the user devices 110 may be clustered together in a user device group 116. Each of the user devices 110 may be associated with one or more corresponding operators. These operators are shown as a user 118a, a user 118b, and a user 118c (collectively users 118) in the user device group 116. In FIG. 1, the user 118a is shown associated with the user device 110b, the user 118b is shown associated with the user device 110c, and the user 118c is shown associated with the user device 110d.

In one or more embodiments the server 102 may comprise one or more databases 122, one or more server input (I)/output (O) interfaces 124, at least one server processor 126, and at least one memory 130 communicatively coupled to one another. In some embodiments the memory 130 may comprise instructions 132, the one or more data exchange operations 104, one or more requests 134, one or more communication levels 136, one or more evaluation levels 138, one or more configuration parameters 140, one or more operational paths 141 comprising one or more path durations 142, one or more sub-operations 143, one or more operation points 144, one or more tolerances 145, one or more modifications 146, the one or more anomalies 108, historical data 147, user information 150 comprising one or more user profiles 152, one or more entitlements 154, and one or more services 156, one or more artificial intelligence (AI) commands 158, configured to train one or more cognitive AI models 160, one or more machine learning (ML) algorithms 162, one or more tokens 163 comprising one or more static tokens 164 and/or one or more dynamic tokens 165, one or more knowledge based commands 166, and one or more reports 168.

Referring to the user device 110a a non-limiting example, the user device 110a may comprise one or more device interfaces 172, one or more server peripherals 174, at least one server processor 176, and at least one server memory 178 communicatively coupled to one another. The server memory 178 may comprise server instructions 180, collected data 182, and/or one or more local applications 184.

Referring to the node 112a a non-limiting example the node 112a may comprise one or more configuration parameter 190a and/or one or more data exchange controls 192a. In the example of FIG. 1, the node 112b includes one or more configuration parameter 190b and/or one or more data exchange controls 192b, the node 112c includes one or more configuration parameter 190c and/or one or more data exchange controls 192c, the node 112d includes one or more configuration parameter 190d and/or one or more data exchange controls 192d, and the node 112e includes one or more configuration parameter 190e and/or one or more data exchange controls 192e.

### System components

### Server

The server 102 is generally any device or apparatus that is configured to process data and communicate with computing devices (e.g., the user devices 110 and/or the nodes 112), additional databases systems and the like via the one or more server I/O interfaces 124 (i.e., a user interface or a network interface). The server 102 may comprise the server processor 126 that is generally configured to oversee operations of the processing engine. The operations of the processing engine are described further below in conjunction with the system 100 described in FIG. 1, the respective operational paths 200a-200c in FIGS. 2A-2C, and the process 300 described in FIG. 3.

The server 102 comprises multiple databases 122 configured to provide one or more memory resources to the server 102 and/or the user devices 110. The server 102 comprises the server processor 126 communicatively coupled with the databases 122, the server I/O interfaces 124, and the memory 130. The server 102 may be configured as shown, or in any other configuration. In one or more embodiments, the databases 122 are configured to store data that enables the server 102 to configure, manage and coordinate one or more middleware systems. In some embodiments the databases 122 store data used by the server 102 to act as a halfway point in between one or more services 156 and other tools or databases.

In one or more embodiments, the server I/O interfaces 124 may be configured to enable wired and/or wireless communications. The server I/O interfaces 124 may be configured to communicate data between the server 102 and other user devices (i.e., the user devices 110 and/or the node 112), network devices (i.e., routers in the network 114), systems, or domain(s) via the network 114. For example, the server I/O interfaces 124 may comprise a WI-FI interface, a LAN interface, a WAN interface, a modem, a switch, or a router. The server processor 126 may be configured to send and receive data using the server I/O interfaces 124. The server I/O interfaces 124 may be configured to use any suitable type of communication protocol. In some embodiments, the server I/O interfaces 124 may be an admin console comprising a web browser base or graphical user interface used to manage a middleware server domain via the server 102. A middleware server domain may be a logically related group of middleware server resources that managed as a unit. A middleware server domain may comprise the server 102 and one or more managed servers. The managed servers may be standalone devices and/or collected devices in the server cluster. The server cluster may be a group of managed servers that work together to provide scalability and higher availability for the services 156. In this regard, the services 156 are developed and deployed as part of at least one domain. In other embodiments, one instance of the managed servers in the middleware server domain may be configured as the server 102. The server 102 provides a central point for managing and configure the managed servers and any of the one or more services 156.

The server processor 126 comprises one or more processors communicatively coupled to the memory 130. The server processor 126 may be any electronic circuitry including but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). The server processor 126 may be a programmable logic device, a microcontroller, a microprocessor, or any suitable combination of the preceding. The one or more server processor 126 are configured to process data and may be implemented in hardware or software executed by hardware. For example, the server processor 126 may be 8-bit, 16-bit, 32-bit, 64-bit or of any other suitable architecture. The server processor 126 may include an arithmetic logic unit (ALU) for performing arithmetic and logic operations, processor registers that supply operands to the ALU and store the results of ALU operations, and a control unit that fetches the instructions 132 from the memory 130 and executes them by directing the coordinated operations of the ALU, registers and other components. In this regard the one or more server processor 126 are configured to execute various instructions. For example, the one or more server processor 126 are configured to execute the instructions 132 to implement the functions disclosed herein such as some or all of those described with respect to FIGS. 1-3. In some embodiments the functions described herein are implemented using logic units FPGAs, ASICs, DSPs, or any other suitable hardware or electronic circuitry.

In one or more embodiments the server I/O interfaces 124 may be any suitable hardware and/or software to facilitate any suitable type of wireless and/or wired connection. These connections may include but not be limited to, all or a portion of network connections coupled to the Internet, an Intranet, a private network, a public network, a peer-to-peer network, the public switched telephone network, a cellular network, a local area network (LAN), a metropolitan area network (MAN), a wide area network (WAN), and a satellite network. The server I/O interfaces 124 may be configured to support any suitable type of communication protocol as would be appreciated by one of ordinary skill in the art. In one or more embodiments, the server I/O interfaces 124 may comprise one or more sensors configured to evaluate physical phenomena surrounding the server 102 and/or one or more of the user devices 110. The sensors may be proximity sensors, optical sensors, and the like.

The memory 130 may be volatile or non-volatile and may comprise a read-only memory (ROM), random-access memory (RAM), ternary content-addressable memory (TCAM), dynamic random-access memory (DRAM), and static random-access memory (SRAM). The memory 130 may be implemented using one or more disks, tape drives, solid-state drives, and/or the like. The memory 130 is operable to store the instructions 132, the one or more data exchange operations 104, the one or more requests 134, the one or more communication levels 136, the one or more evaluation levels 138, the one or more configuration parameters 140, the one or more operational paths 141 comprising the one or more path durations 142, the one or more sub-operations 143, the one or more operation points 144, the one or more tolerances 145, the one or more modifications 146, the one or more anomalies 108, the historical data 147, the user information 150 comprising the one or more user profiles 152, the one or more entitlements 154, and the one or more services 156, the one or more artificial intelligence (AI) commands 158 configured to train one or more cognitive AI models 160, the one or more machine learning (ML) algorithms 162, the one or more tokens 163, comprising the one or more static tokens 164 and/or the one or more dynamic tokens 165, the one or more knowledge based commands 166, and the one or more reports 168. The instructions 132 may comprise any suitable set of instructions, logic, rules, or code operable to execute the server processor 126.

The one or more data exchange operations 104 may be one or more operations configured to convert one or more data elements to obtain, distribute, and/or modify one or more data objects. Further, the data exchange operations 104 may be one or more operations configured to modify and/or exchange data objects after being triggered by one or more requests 134. The one or more requests 134 may be one or more information strings, alphanumeric data, and/or configuration commands to be exchanged in a data network.

In one or more embodiments, the data exchange operations 104 are configured to create, analyze, manage, and update one or more tokens 163. The data exchange operations 104 may be configured to communicate one or more of the requests 134 with the one or more decentralized networks 106 via user and/or network interfaces and connections. The data exchange operations 104 may be configured to perform one or more of the operations in the operational paths 200a-200c described respectively in reference to FIGS. 2A-2C and the process 300 described in reference to FIG. 3. In some embodiments, the data exchange operations 104 may be configured to update one or more user profiles 152 in the user information 150. In some embodiments, the server 102 may be configured to generate the tokens 163 to perform one or more of the data exchange operations 104 with the decentralized network 106 as triggered by one or more of the user devices 110.

The one or more requests 134 may be one or more communications configured to provide triggers in the form of communication or control signals to start operations such as fetching the instructions 132 or running one or more additional data exchange operations 104. The requests 134 may provide user information 150 to the server 102 to indicate at least one user profile 152 associated with one or more of the entitlements 154 to access and/or modify any of the services 156 available in the server 102 and/or one or more of the local applications 184 in the user devices110. The requests 134 may be configured to provide lists security information and configuration commands that the server 102 uses to set up a specific service 156 for one of the user devices 110. The requests 134 may comprise data that provides starting procedure configuration to the server 102. In one or more embodiments the requests 134 may be optimized instructions that trigger establishing of a specific procedure in the server 102.

In yet other embodiments, one or more of the user devices 110 may request the decentralized networks 106 via the server 102 to perform one or more data exchange operations 104 an generate the tokens 163 dynamically or periodically over time in accordance with one or more configuration parameters 140. The configuration parameters 140 may at least be partially based on the requests 134 from the user devices 110. The triggers received from the user devices 110 may be referenced as part of one or more configuration parameters 140. In some embodiments the tokens 163 may be a non-fungible token (NFT) that are generated along encrypted geolocation of the user devices 110 and point-of-exchange (PoE) information. The PoE information may comprise location information in which a request 134 is triggered by one of the user devices 110. In some embodiments, the PoE information indicate a relation between a specific data exchange operation 104a, one or more entitlements 154, and one or more user profiles 152 obtained when a data exchange is attempted. The tokens 163 may be a string of numbers, alphanumeric characters, one or more words or phrases, one or more letters, and/or symbols that are minted in the decentralized networks 106 (e.g., a blockchain) in accordance with a specific protocol and/or data exchange encryption. In some embodiments, the tokens 163 are generated in accordance with one or more token attributes. The server 102 may be configured to present data exchange output receipts in one or more reports 168 to the user devices 110.

In some embodiments the data exchange operations 104 may be executed by the server processor 126 configured to enable data objects comprising one or more data elements to be exchanged between the server 102, the user devices 110, and/or one or more additional devices communicatively coupled to the server 102 via the network 114. In one or more embodiments, the data exchange operations 104 may be configured to indicate one or more data objects (e.g., via data object information) to be exchanged between the server 102 and at least one of the user devices 110.

In one or more embodiments, the one or more data exchange operations 104 may be one or more operations performed by one or more services 156. The data exchange operations 104 may be one or more operations comprising multiple stages and/or transitions at different services 156. For example, one or more data exchange operations 104 may be configured to start at one service 156a that transitions to other services 156b-156d. For example, the server 102 may be configured to set up one or more data exchange operations 104 and one or more data elements and/or data records to be modified by the data exchange operations 104 performed by one or more services 156. The one or more data elements may be individual data in one or more data objects. The data elements may be alphanumeric bitstrings comprising a specific format. The data elements may be data information configured to reference data objects stored in a specific database. The one or more data records may be one or more tables ledgers files and/or data documents comprising information relating to one or more data objects. In some embodiments, each of the data exchange operations 104 may be configured to modify one or more data elements and/or one or more data records. The server 102 may be configured to keep track and/or monitor one or more of the data elements and/or the data records as the data exchange operations 104 transition from one service 156 to another service 156.

The one or more communication levels 136 may be one or more levels configured to guide analysis and/or tracking of anomalies 108 in one or more hops (e.g., transitions) of the data exchange operation 104a along a specific operational path 141a. The communication levels 136 may be full path (e.g., enriched) communication levels that comprise tracking inputs and outputs associated with the data exchange operation 104a from an origin point (e.g., one of the operation points 144) to a completion point (e.g., one of the operation points 144) in the operational path 141a. The communication levels 136 may be granularity communication levels that comprise tracking inputs and outputs associated with one or more specific sub-operations 143 at one or more specific operation points 144 in the operational path 141a.

The one or more evaluation levels 138 may be one or more levels configured to guide analysis and/or tracking of anomalies 108 as data is modified in one or more hops (e.g., transitions) of the data exchange operation 104a along a specific operational path 141a. The evaluation levels 138 may be operation-specific levels 138a (e.g., request levels) that cause a given dynamic token 165a to reference starting data to be modified by all of the sub-operations 143 in a given operational path 141b. The evaluation levels 138 may be record-specific levels 138b (e.g., record levels) that cause the given dynamic token 165a to reference the starting data to be modified by each of the sub-operations 143 in the given operational path 141b. The evaluation levels 138 may be data element-specific levels 138c (e.g., data-element levels) that cause the given dynamic token 165a to reference the starting data to be modified by at least one of the sub-operations 143 in the given operational path 141c. In one or more embodiments the evaluation levels 138 may be guidance for updating one or more tokens 163 as the given operational paths 141 are completed.

The one or more operational paths 141 may be one or more processes for completing one or more data exchange operations 104. Each operational path 141 may comprise at least one path duration 142 one or more sub-operations 143, and one or more operation points 144. The one or more path durations 142 may be a time-based duration and/or an operation-based duration in which a given data exchange operation 104 is expected to be completed. The one or more sub-operations 143 may be one or more operations performed in accordance with one or more communication levels 136 and/or one or more evaluation levels 138. The one or more operation points 144 may be one or more hops and/or stops in which data is modified to complete a given data exchange operation 104.

The one or more tolerances 145 may be one or more specific numbers and/or number ranges associated with a specific parameter and/or indicator. The one or more tolerances 145 may be a specific value representing a higher boundary or a lower boundary. The one or more tolerances 145 may be one or more threshold ranges comprising higher boundaries and lower boundaries. The one or more tolerances 145may be a percentage value representing a similarity and/or a difference between one or more values assigned as tolerances for current configuration parameters 140, one or more reference data element values and/or one or more reference data record values. The one or more tolerances 145 may be determined based on information associated with the requests 134. The one or more tolerances 145 may be determined dynamically over time The one or more tolerances 145 may be predefined and/or predetermined in accordance with information in activity associated with one or more of the requests 134. In some embodiments, the server 102 may be configured to calculate the one or more tolerances 145 based on information obtained via the server I/O interfaces 124 and/or device interfaces 172.

The one or more modifications 146 may be recommendations presented to the user devices 110 based on the one or more of the sub-operations 143 performed in the operational paths 141. The modifications 146 may comprise one or more dynamic configuration commands to modify the one or more entitlements 154, the one or more tokens 163, and/or the one or more configuration parameters 140. In one or more embodiments, the dynamic configuration commands may comprise the one or more application configuration parameters 140 configured to control operations of the services 156 and/or the local applications 184. Each configuration command of the application configuration parameters 140 may be configured to dynamically provide control information to perform one or more of the operations based at least in part upon the analyzed data during the operational paths 141. The modifications 146 may provide preventive solutions to remove, reduce, and/or eliminate anomalies 108 as a data exchange operation 104 is completed. In any integrated system where multiple applications (e.g., services 156) interact with each other the system 100 may thoroughly perform impact checks of any changes to operations and whether modifications are needed to ensure any change in data is not impacting performance of the services 156.

In one or more embodiments one or more anomaly detection operations may comprise one or more operations executed in conjunction with the one or more operations of the ML algorithms 162. The one or more anomaly detection operations may be configured to evaluate data exchanged between the user devices 110 and/or the server 102. In one or more embodiments the anomaly detection operations may be configured to evaluate the path durations 142, the sub-operations 143, and/or the operation points 144 for a specific operational path 141a. The anomaly detection operations may be configured to generate and analyze one or more communication operations to confirm whether one or more entities associated with communication operations are legitimately associated with at least one of the user devices 110. The anomaly detection operations may be one or more operations in which the server 102 is configured to confirm whether one or more communication operations associated with a specific entity belong to a specific user device 110. In some embodiments the anomaly detection operations may be configured to determine one or more anomalies 108 in data changes and/or modifications 146 as data is modified in a given operational path 141. The one or more anomalies 108 may be one or more values configured to provide indicators of possible adverse changes to the network 114 the server 102 and/or one or more services 156. The anomalies 108 may be determined as results of evaluating modifications 146 (e.g., changes) to the starting data and/or one or more data elements and/or record elements along a given operational path 141. The anomalies 108 may be determined after evaluating one or more tokens 163.

The historical data 147 may be historic information associated with one or more data exchange operations 104 in a communication network. The historical data 147 may comprise one or more historic indicators representing one or more trends associated with usage of tokens 163 for a specific data exchange operation 104, specific services 156, and/or specific configuration parameters 140.

The user information 150 may comprise the one or more user profiles 152 one or more entitlements 154, and one or more services 156. In one or more embodiments the user profiles 152 may comprise multiple profiles associated with one or more entitlements 154 to access and/or modify the services 156. Each of the user profiles 152 may be associated with one or more entitlements 154. The entitlements 154 may indicate that a given user device 110 is allowed to access one or more network resources in accordance with the one or more rules and policies. The entitlements 154 may indicate that a given user device 110 is allowed to perform one or more operations in the system 100 (e.g., provide a specific application data access to one of the users 118). To secure or protect operations of the user devices 110 from bad actors the entitlements 154 may be assigned to a given user profile 152 in accordance with updated security information which may provide guidance parameters to the use of the entitlements 154 based at least upon corresponding rules and policies. In one or more embodiments, the one or more services 156 are access to one or more application operations performed in accordance with the application data. In some embodiments the user profiles 152 may comprise multiple profiles for users (e.g., user 118). Each user profile 152 may comprise one or more entitlements 154. As described above, the entitlements 154 may indicate that a given user 118 is allowed to access one or more network resources in accordance with one or more rules and policies. The entitlements 154 may indicate that a given user is allowed to perform one or more data exchanges with the tokens 163 via the decentralized networks 106. In one or more embodiments each of the user profiles 152 may comprise information about at least one user 118 entitled to trigger one or more data exchange operations 104 in the decentralized network 106.

In one or more embodiments, the ML algorithms 162 may be executed by the server processor 126 to evaluate the requests 134. Further, the ML algorithms 162 may be configured to interpret and transform the requests 134 and/or the instructions 132 into structured data sets and subsequently stored as files or tables. The ML algorithms 162 may cleanse, normalize raw data, and derive intermediate data to generate uniform data in terms of encoding, format, and data types. The ML algorithms 162 may be executed to run user queries and advanced analytical tools on the structured data. The ML algorithms 162 may be configured to generate the one or more AI commands 158 based on one or more results of the testing operations. The AI commands 158 may be parameters that proactively trigger one or more of the data exchange operations 104 in accordance with path communication levels 136 and/or evaluation levels 138. The AI commands 158 may be combined with the existing instructions 132 to dynamically trigger and/or perform the data exchange operations 104. The AI commands 158 may be configured to trigger one or more cognitive AI operations in accordance with one or more models 160. The models 160 may be trained by the one or more ML algorithms 162 based on historic information associated with any data exchange operations 104 performed with the server 102.

In one or more embodiments rules and policies may be security configuration commands and/or regulatory operations predefined by an organization or one or more users 118. In one or more embodiments the rules and policies may be dynamically defined by the one or more users 118. The rules and policies may be prioritization rules configured to instruct one or more user devices 110 to perform one or more operations in the system 100 in a specific data exchange operation 104. The one or more rules and policies may be predetermined or dynamically assigned by a corresponding user 118 or an organization associated with the users 118.

The one or more tokens 163 may comprise one or more authentication parameters and/or one or more communication parameters configured to verify authenticity of one or more portions of data associated with the data exchange operations 104. The services 156 may be configured to generate one or more tokens. Herein, the server 102 may be configured to determine one or more verification elements and save these verification elements in the form of one or more tokens 163. In one or more embodiments, the tokens 163 may be configured to provide reference verification information to confirm whether verification information received is authentic and/or whether one or more data exchange operations transitions from another service 156 are acceptable or not acceptable. The tokens 163 may comprise access credentials associated with one or more services 156 expected to perform one or more of the data exchange operations 104. The one or more tokens 163 may be configured to reference whether a specific service 156 is entitled to access network resources associated with performing one or more data exchange operations 104 at the specific service 156. In some embodiments, the tokens 163 may comprise one or more data elements referencing a service precedence and/or a service destination. The one or more static tokens 164 may be one or more tokens 163 configured to be generated and/or eliminated. The one or more dynamic tokens 165 may be one or more tokens 163 configured to be generated, eliminated, and/or modified. In some embodiments, the tokens 163 may be creates, deleted, and/or modified after one or more of the services 156 trigger a specific data exchange operation 104. The tokens 163 may be modified, updated, removed, and/or eliminated in accordance with one or more smart contracts.

The one or more knowledge base commands 166 may be one or more indicators configured to provide information associated with one or more knowledge domains and/or operations of entities accessing the network 114. The knowledge base commands 166 may be stored in one or more formats. The server processor 126 may be configured to generate the one or more knowledge base commands 166 based on information collected from one or more specific services 156. The knowledge base commands 166 may be replaced, updated, and/or modified dynamically. The knowledge base commands 166 may be replaced, updated, and/or modified periodically.

The one or more reports 168 may comprise data indicating warnings and alerts among other information. In some embodiments, the one or more reports 168 may be audio and/or visual signaling presented in the one or more server I/O interfaces 124 and/or the one or more device peripherals 174. In one or more embodiments, the one or more reports 168 may comprise a release roadmap to incorporate the one or more possible anomaly corrections and/or suggestions into the configuration parameters 140. In some embodiments, the one or more reports 168 may be generated to indicate one or more instructions 132 to incorporate the one or more possible modification suggestions into the configuration parameters 140.

In one or more embodiments the data exchange operations 104 may be one or more operations configured to be performed at multiple locations. The data exchange operations 104 may be operations distributed to exchange one or more data objects associated with one or more user devices 110. The data exchange operations 104 may be distributed in multiple locations physically separated from one another. The data exchange operations 104 may be testing operations performed to evaluate one or more portions of application data associated with one or more of the services 156.

In one or more embodiments the databases 122 may be one or more data and/or information repositories configured to store structured and/or unstructured information. In one example, the server 102 may determine the server processor 126 is available (e.g., running) to perform a specific service 156. In another example, the server 102 may determine that a specific managed server is running to enable a testing application and/or perform the specific service 156 upon receiving a server response indicating that a corresponding managed server is available to perform the service 156. The databases 122 may be configured to store one or more tokens 163 starting data and/or one or more data anomalies of data instead of storing coded data In this regard the one or more tokens 163 and/or the starting data may be encoded in accordance with predefined encoder configured to determine integrity of data and/or information exchanged with the server 102.

### User device

In one or more embodiments, each of the user devices 110 (e.g., the user device 110a and/or the user devices 110b-110d in the device group 116) may be any computing device configured to communicate with other devices, such as the server 102, other user devices 110 in the user device group 116, databases, and the like in the system 100. Each of the user devices 110 may be configured to perform specific functions described herein and interact with the server 102 and/or any other user devices 110. Examples of the user devices 110 comprise, but are not limited to, a laptop, a computer, a smartphone, a tablet, a smart device, an IoT device, a simulated reality device, an augmented reality device, or any other suitable type of device. The requests 134 may be provided by the user devices 110 via one or more interfaces comprising input displays, voice microphones, or sensors capturing gestures performed by a corresponding user 118.

The user devices 110 may be hardware configured to create, transmit, and/or receive information. The user devices 110 may be configured as a provider node or as worker nodes. The user devices 110 may be configured to receive inputs from a user, process the inputs, and generate data information or command information in response. The data information may include documents or files generated using a graphical user interface (GUI).

Referring to the user device 110a as a non-limiting example, the command information may include input selections/commands triggered by a user using a peripheral component or one or more device peripherals 174 (i.e., a keyboard) or an integrated input system (i.e., a touchscreen displaying the GUI). The user devices 110 may be communicatively coupled to the server 102 via a network connection (i.e., the device peripherals 174). The user devices 110 may transmit and receive data information, command information, or a combination of both to and from the server 102 via the device interfaces 172. In one or more embodiments, the user devices 110 are configured to exchange data, commands, and signaling with the server 102. In some embodiments, the user devices 110 are configured to receive at least one firewall (e.g., security system configuration and/or information) configuration from the server 102 to implement a firewall (one of the one or more local applications operating as a security system) at one of the user devices 110.

In one or more embodiments, the device interfaces 172 may be any suitable hardware or software (e.g., executed by hardware) to facilitate any suitable type of communication in wireless or wired connections. These connections may comprise, but not be limited to, all or a portion of network connections coupled to additional user devices 110, the server 102, the Internet, an Intranet, a private network, a public network, a peer-to-peer network, the public switched telephone network, a cellular network, a LAN, a MAN, a WAN, and a satellite network. The device interfaces 172 may be configured to support any suitable type of communication protocol.

In one or more embodiments, the one or more device peripherals 174 may comprise audio devices (e.g., speaker, microphones, and the like), input devices (e.g., keyboard, mouse, and the like), or any suitable electronic component that may provide a modifying or triggering input to the user devices 110. For example, the one or more device peripherals 174 may be speakers configured to release audio signals (e.g., voice signals or commands) during media playback operations. In another example, the one or more device peripherals 174 may be microphones configured to capture audio signals. In one or more embodiments, the one or more device peripherals 174 may be configured to operate continuously, at predetermined time periods or intervals, or on-demand.

The device processor 176 may comprise one or more processors communicatively coupled to and in signal communication with the device interfaces 172, the device peripherals 174, and the device memory 178. The device processor 176 is any electronic circuitry, including, but not limited to, state machines, one or more CPU chips, logic units, cores (e.g., a multi-core processor), FPGAs, ASICs, or DSPs. The device processor 176 may be a programmable logic device, a microcontroller, a microprocessor, or any suitable combination of the preceding. The one or more processors in the device processor 176 are configured to process data and may be implemented in hardware or software executed by hardware. For example, the device processor 176 may be an 8-bit, a 16-bit, a 32-bit, a 64-bit, or any other suitable architecture. The device processor 176 may comprise an ALU to perform arithmetic and logic operations, processor registers that supply operands to the ALU, and store the results of ALU operations, and a control unit that fetches software instructions such as device instructions 180 from the device memory 178 and executes the device instructions 180 by directing the coordinated operations of the ALU, registers, and other components via a device processing engine (not shown). The device processor 176 may be configured to execute various instructions.

The device memory 178 may comprise multiple operation data and one or more local applications 184 associated with the server 102. The operation data may be data configured to enable one or more data processing operations such as those described in relation with the server 102. The operation data may be partially or completely different from those comprised in the memory 130. The local applications 184 may be one or more of the services described in relation with the server 102. In some embodiments, the local applications 184 may be partially or completely different from those comprised in the memory 130.

In one or more embodiments, the collected data 182 may be information collected by the user device 110a using the device interfaces 172 and/or the device peripherals 174. For example, the collected data 182 may be one or more of the samples of physical phenomena collected using one or more sensors communicatively couples with the user device 110a.

### Network

The network 114 facilitates communication between and amongst the various devices of the system 100. The network 114 may be any suitable network operable to facilitate communication between the server 102 and the user devices 110 of the system 100. The network 114 may include any interconnecting system capable of transmitting audio, video, signals, data, data packets, messages, or any combination of the preceding. The network 114 may include all or a portion of a public switched telephone network (PSTN), a public or private data network, a LAN, a MAN, a WAN, a local, regional, or global communication or computer network, such as the Internet, a wireline or wireless network, an enterprise intranet, or any other suitable communication link, including combinations thereof, operable to facilitate communication between the devices. The network 114 may be a light-based network configured to provide communications using fiber optical cables and/or other infrastructure configured to transfer light.

### Decentralized network

In one or more embodiments the decentralized networks 106 comprises a peer-to-peer networking protocol that enables development of serverless applications. The decentralized networks 106 may include multiple electronic components or devices (i.e., nodes 112) comprising specific node data. The nodes 112 may not be required to store or validate all data in the decentralized network 106 Instead validation of each node’s data may be obtained via peer accountability. The decentralized networks 106 may be a blockchain network configured to perform one or more decentralized operations.

In some embodiments the nodes 112 may include only their own data and a reference to all other data in a given decentralized network 106 in accordance with rules and/or policies preestablished by an electronic component or device outside the given decentralized network 106 (e.g., one or more servers such as the server 102). Each node may comprise one or more configuration parameters 190 and/or one or more data exchange controls 192. The configuration parameters 190 may determine how the nodes 112 interact with each other and the server 102. The configuration parameters 190 may be updated dynamically or periodically with additional data received as updates via one or more planning components (e.g., electronic devices or components configured to provide updates to the configuration parameters 190). The updates may be triggered by a perceived lack of knowledge level in the nodes 112. A perceived knowledge level in the nodes 112 may be identified via node scores (not shown) received from the server 102 as feedback.

In one or more embodiments each node (i.e., out of nodes 112) in the given decentralized network 106 includes knowledge-specific information and information associated with peer accountability and a perceived knowledge level. Specifically, referencing the node 112a as a non-limiting example, includes configuration parameters 190a and data exchange controls 192a. The data exchange controls 192a may include information corresponding to at least one knowledge domain configured to perform interactions of one or more user devices 110. In one or more embodiments, the node 112a may be configured to receive one or more of initial tokens. Upon receiving the tokens 163, the node 112a may be configured to determine whether any of entitlements 154 of the initial tokens correspond to the knowledge information included in the data exchange controls 192a.

In other embodiments the node 112a includes a processor not shown configured to provide updates corresponding to specific updated data exchange controls 192a. The processor in the node 112a may be configured to provide updated tokens directly to the server processor 126. Further, the processor of the node 112a may be configured to route any initial tokens that are not updated to one of the other nodes 112 in accordance with one or more configuration parameters 190 governing the given decentralized network 106. The data exchange controls 192 at a given node 112 may be configured to generate a token 163 representative of a request 134 and perform a corresponding interaction in one or more of the decentralized networks 106. In some embodiments, the data exchange controls 192 may enable the token 163 to perform interactions between a first decentralized network 106 and a second decentralized network 106. Each of the decentralized networks 106 may comprise corresponding configuration information configured to interpret the requests 134 in the given token 163.

In the example of FIG. 1, a representation of the decentralized networks 106 includes five nodes 112a-112e. However, additional nodes or fewer nodes may be included. In some embodiments, each of the nodes 112 includes corresponding configuration parameters 190 and corresponding data exchange controls 192. In the decentralized networks 106 of FIG. 1, the node 112a includes the configuration parameters 190a and the updated data exchange controls 192a; the node 112b includes the configuration parameters 190b and the updated data exchange controls 192b; the node 112c includes the configuration parameters 190c and the updated data exchange controls 192c; the node 112d includes the configuration parameters 190d and the updated data exchange controls 192d and the node 112e includes the configuration parameters 190e and the updated data exchange controls 192e.

### Operational Flow

In one or more embodiments, the server 102 and/or user devices 110 are endpoints (e.g., ATM, user device) configured to request access to network resources using one or more data exchange operations 104. In some embodiments, a source application may call one or more transaction anomaly detection operations as a service using service APIs in an embedded way/on-demand and/or sends a trigger to a model 160 as an event to evaluate one or more operations performed in a data exchange operation 104 to potentially detect one or more anomalies 108 over a predefined time duration (e.g., period of time). In response to triggering the transaction anomaly operations, the server 102 may be configured to select an operational path 141a in which the data exchange operation 104 may be performed, identify and/or generate and/or assign a static token 164a to the operational path 141a. Herein, the server 102 may be configured to execute an ML algorithm 162 using reservoir computing to identify a target operational path 141a for a specific transaction type. The server 102 may use generative AI commands 158 to create and/or generate the static token 164a. The server 102 may execute the ML algorithm 162 to dynamically manage temporal operational paths 141 (e.g., there may be multiple operational paths 141 and alternatives available at any given time) and data (e.g., starting data data may be further divided into multiple sub-operations and/or aggregated in accordance with a rule (e.g., depending on source and/or nature of data). The static token 164a may be generated, created, and/or selected in accordance with one or more communication levels 136. The communication levels 136 may comprise full path (e.g., enriched) communication levels 136a and/or granular communication levels 136b. The full path communication levels 136a may comprise tracking initial and/or final hops and/or transmissions of starting data between most multiple sub-operations 143 of a specific operational path 141. The static tokens 164a associated with a full path communication level 136a may be configured to track data integrity from a starting point associated with a first system associated and an ending point associated with a last system in the specific operational path 141a. The granular communication levels 136b may comprise tracking individual hops and/or transmissions of starting data between one or more sub-operations 143 of the specific operational path 141. The static tokens 164b associated with a granular communication levels 136b may be configured to track data integrity from the starting point associated with the first system associated, the ending point associated with the last system, and any other operation points 144 in between in the specific operational path 141a.

In one or more embodiments the server 102 may be configured to determine create generate and/or select a dynamic token 165 representative of one or more possible modifications 146 of starting data as the starting data transitions between one or more operation points 144 and/or sub-operations 143 in a specific operational path 141. The server may be configured to execute the ML algorithm 162 along with one or more generated AI commands 158 to create, generate, assign, and/or select a dynamic token 165 for data used in the data exchange operation 104 (e.g., a data exchange operation 104 may comprise multiple records and/or a record may comprise one or more multiple data elements). The server 102 may be configured to define rules and/or policies setting a time duration, probability of change and/or modifications 146 of data over the operational path 141. The dynamic token 165 may be configured to maintain information relating to changes of the data as the data changes over the operational path 141. The dynamic tokens 165 may comprise one or more evaluation levels 138. The evaluation levels 138 may be specific to one or more operations, records, and/or data fields. The evaluation levels 138 may comprise operation-specific levels 138a, record-specific levels 138b, and/or data element-specific levels 138c. The operation-specific levels 138a may comprise tracking data changes at an operation level as sub-operations 143 modify the data. The dynamic tokens 165 modified at the operation-specific levels 138a may be configured to reference identifiers captured, such as unique transaction identifiers, application numbers, operation names, and timestamps among others. The record-specific levels 138b may comprise tracking of records in a data exchange operation 104 as there may be multiple records in a single transaction. The dynamic token 165 modified at the record-specific levels 138b may be configured to reference identifiers captured, such as unique record identifiers, sub-record identifiers if any headers and/or lines, application number, operation names, and timestamp among others. The data element-specific levels 138c may comprise tracking of data elements as the data exchange operation 104 flows in the operational path 141. The dynamic token 165 modified at the data element-specific levels 138c may be configured to reference identifiers captured, such as unique data elements identifiers, sub-record identifiers if any headers and/or lines, application number, operation names, and timestamp among others.

In one or more embodiments, the server 102 uses dynamic tokens 165 at multiple levels to track a dynamic nature of starting and/or operational data such as data transformation, data enrichment, data conformation according to application schemas, and the like. The server 102 may be configured to update the dynamic tokens 165 with the aid of the decentralized networks 106.

In one or more embodiments the server 102 may be configured to perform one or more anomaly detection operations and one or more anomaly resolution operations. The one or more anomaly detection operations may be configured to detect one or more anomalies 108 as sub-operations 143 modify data along the operational path 141. The server 102 may be configured to execute the ML algorithm 162 to create rules to compare operational data at every hop in the operational path 141, to be used at identifying variance in one or more of the sub-operations 143. These rules may be matched to a static token 164 (e.g., operational path 141 and one or more types of services 156 involved) and a dynamic token 165 (e.g., how data is transformed, divided, and/or aggregated at various services 156 in the operational path 141. The server 102 may be configured to use these rules as techniques to extract/parse content from the dynamic tokens 165, which identifies exact location of services 156 involved in one or more sub-operations 143. The one or more anomaly resolution operations may be configured to resolve, eliminate, and/or remove one or more anomalies 108 as sub-operations 143 modify data along the operational path 141. Once an anomaly 108 is detected, the server 102 may be configured to perform one or more error corrections to be done at transaction level, a data record level, or a data element level using the respective content of dynamic tokens 165 of the static tokens 164. At any point information from the static tokens 164 and/or the dynamic tokens 165 may be extracted to be modified and/or analyzed.

### Example operational paths

FIGS. 2A-2C show respective multiple example operational paths 200a-200c in which the system 100 of FIG. 1 is configured to evaluate one or more data exchange operations 104, in accordance with one or more embodiments. The operational paths 200a-200c may be configured to complete at least one specific data exchange operation 104.

In FIG. 2A, the operational path 200a comprises an origin point 202, a completion point 204, and one or more additional operation points 144. The operational path 200a may be performed over a path length 210 (e.g., a path duration 142a) which may last a predefined and/or dynamically determined time duration. Further, the path length 210 may be based on one or more operation points 144a-144c. In the example of FIG. 2A, the origin point 202 may be a network device 212 and the completion point 204 may be a service 220. Further, the operation point 144a may be a cloud service 214, the operation point 144b may be one or more firewalls 216, and the operation point 144c may be a service 218. In some embodiments the network device 212 may perform one or more modifications 146a to starting data and transfer a first modified version of the starting data in one or more operations 222 to the cloud service 214, the cloud service 214 may perform one or more modifications 146b to previously modified starting data and transfer a second modified version of the starting data in one or more operations 224 to the one or more firewalls 216, the one or more firewalls 216 may perform one or more modifications 146c to previously modified starting data and transfer a third modified version of the starting data in one or more operations 226 to the service 218, and the service 218 may perform one or more modifications 146d to the starting data and transfer a fourth modified version of the starting data in one or more operations 228 to the service 220.

In some embodiments, the data exchange operation 104 may be completed between the origin point 202 and the completion point 204 over the path length 210. As the starting data changes over the operations 222-228, the dynamic token 165a generated, selected, and/or determined for the operational path 200a may be modified using the ML algorithm 162 and/or the nodes 112 in the decentralized networks 106 over the path length 210. The network device 212 may be one or more of the user devices 110. The cloud service 214, the service 218, and the service 220 may be one or more of the services 156 and/or one or more of the local applications 184 in one or more of the user devices 110. The one or more firewalls 216 may be one or more structures created and/or maintained by the server 102 and/or one or more of the user devices 110. The one or more firewalls 216 may be one or more structures created and/or maintained by one or more of the services 156 and/or one or more of the local applications 184 in one or more of the user devices 110.

In FIG. 2B, the operational path 200b comprises an origin point 242, a completion point 244, and one or more additional operation points 144. The operational path 200b may be performed over a path length 250 (e.g., a path duration 142b) which may last a predefined and/or dynamically determined time duration. Further, the path length 250 may be based on the operation point 144d. In the example of FIG. 2B, the origin point 242 may be a network device 252 and the completion point 244 may be a service 256. Further, the operation point 144d may be a service 254. In some embodiments, the network device 252 may perform one or more modifications 146e to starting data and transfer a fifth modified version of the starting data in one or more operations 262 to the service 254, and the service 254 may perform one or more modifications 146f to the starting data and transfer a sixth modified version of the starting data in one or more operations 264 to the service 256.

In some embodiments, the data exchange operation 104 may be completed between the origin point 242 and the completion point 244 over the path length 250. As the starting data changes over the operations 262 and 264, the dynamic token 165b generated selected and/or determined for the operational path 200b may be modified using the ML algorithm 162 and/or the nodes 112 in the decentralized networks 106 over the path length 250. The network device 252 may be one or more of the user devices 110. The service 254 and the service 256 may be one or more of the services 156 and/or one or more of the local applications 184 in one or more of the user devices 110. The network device 252 may comprise one or more firewalls. The one or more firewalls may be one or more structures created and/or maintained by the server 102 and/or one or more of the user devices 110. The one or more firewalls may be one or more structures created and/or maintained by one or more of the services 156 and/or one or more of the local applications 184 in one or more of the user devices 110.

In FIG. 2C, the operational path 200c comprises an origin point 272, a completion point 274, and one or more additional operation points 144. The operational path 200c may be performed over a path length 280 (e.g., a path duration 142c) which may last a predefined and/or dynamically determined time duration. Further, the path length 280 may be based on one or more operation points 144e-144i. In the example of FIG. 2C, the origin point 272 may be a network device 282 and the completion point 274 may be a service 288. Further, the operation point 144e may be a network device 283, the operation point 144f may be a network device 284 the operation point 144g may be a cloud service 285, the operation point 144h may be one or more firewalls 286, and the operation point 144i may be a service 287. In some embodiments, the network device 282 may perform one or more modifications 146g to starting data and transfer a first modified version of the starting data in one or more operations 292 to the network device 283, the network device 282 may perform one or more modifications 146h to starting data and transfer a second modified version of the starting data in one or more operations 293 to the network device 284, the network device 283 may perform one or more modifications 146i to previously modified starting data and transfer a third modified version of the starting data in one or more operations 294 to the cloud service 285, the network device 283 may perform one or more modifications 146j to previously modified starting data and transfer a fourth modified version of the starting data in one or more operations 295 to the cloud service 285, the cloud service 285 may perform one or more modifications 146k to previously modified starting data and transfer a fifth modified version of the starting data in one or more operations 296 to the one or more firewalls 286, the one or more firewalls 286, may perform one or more modifications 146l to previously modified starting data and transfer a sixth modified version of the starting data in one or more operations 297 to the service 287, and the service 287 may perform one or more modifications 146m to the starting data and transfer a seventh modified version of the starting data in one or more operations 298 to the service 288.

In some embodiments, the data exchange operation 104 may be completed between the origin point 272 and the completion point 274 over the path length 280. As the starting data changes over the operations 292-298, the dynamic token 165c generated, selected, and/or determined for the operational path 200c may be modified using the ML algorithm 162 and/or the nodes 112 in the decentralized networks 106 over the path length 280. The network device 282-284 may be one or more of the user devices 110. The cloud service 285, the service 287, and the service 288 may be one or more of the services 156 and/or one or more of the local applications 184 in one or more of the user devices 110. The one or more firewalls 286 may be one or more structures created and/or maintained by the server 102 and/or one or more of the user devices 110. The one or more firewalls 286 may be one or more structures created and/or maintained by one or more of the services 156 and/or one or more of the local applications 184 in one or more of the user devices 110.

In one or more embodiments, the server 102 may determine that the operational paths 200a-200c are three different paths available to perform a same data exchange operation 104a within a period of time. Herein the server 102 may be configured to execute the ML algorithm 162 to determine one of the operational paths 200a-220c over the other for one or more reasons. In some embodiments the server 102 may be configured to determine one or more of the operational paths 200a-200c over other operational paths 141 after comparing several options and/or considering one or more preferences. In some embodiments the server 102 may determine that the operational paths 200a-200c are three different paths available to perform different data exchange operations 104a-104c within another period of time.

### Example process to dynamically detect anomalies in data exchange operations

FIG. 3 illustrates an example flowchart of a process 300 configured to dynamically detect anomalies 108 in data exchange operations 104, in accordance with one or more embodiments. Modifications, additions, or omissions may be made to the process 300. The process 300 may comprise more, fewer. or other operations than those shown in FIG. 3. For example, operations may be performed in parallel or in any suitable order. While at times discussed as the server 102, the user devices 110, the nodes 112, or components of any of thereof performing operations described in operations 302-332 in the process 300, any suitable system or components of the system 100 may perform one or more operations of the process 300. For example, one or more operations of the process 300 may be implemented at least in part in the form of instructions 132 of FIG. 1, stored on non-transitory, tangible, machine-readable media (e.g., a non-transitory computer-readable medium such as server memory 130 of FIG. 1) that when run by one or more processors (e.g., the server processor 126 of FIG. 1) may cause the one or more processors to perform operations described in operations 302-332.

The process 300 starts at operation 302, where the server 102 is configured to receive a request 134a to perform a data exchange operation 104a at a communication level 136a and an evaluation level 138a. At operation 304 the server 102 is configured to determine one or more configuration parameters 140 based on the data exchange operation 104. The configuration parameters 140 may comprise guidance to perform the data exchange operation 104a. At operation 306, the server 102 is configured to execute one or more ML algorithms162 to determine an operational path 141a that may be configured to complete the data exchange operation 104 over a path duration 142a based on the configuration parameters 140. Herein, the communication level 136a and the evaluation level 138a may be configured to guide anomaly detection operations as the data exchange operation 104a is completed. Further, the configuration parameters 140 may be configured to guide completion of the data exchange operation 104a based on the communication level 136a and the evaluation level 138a. The ML algorithm 162 may, when executed, be configured to evaluate data in accordance with one or more ML models 160 to perform the one or more operations. The operational path 141a may comprise one or more sub-operations 143a to be performed over the path duration 142a to complete the data exchange operation 104. At operation 308, the server 102 is configured to assign a static token 164a to the data exchange operation 104a based on the communication level 136a. The static token 164a may reference a set of sub-operations 143a to be performed on the operational path 141a over the path duration 142a. At operation 310, the server 102 is configured to assign a dynamic token 165a to the data exchange operation 104a based on the evaluation level 138a. The dynamic token 165a may reference starting data to be modified by the sub-operations 143a on the operational path 141a over the path duration 142a. At operation 312, the server 102 is configured to create one or more tolerances 145a for one or more possible changes to the starting data based on the communication level 136a and the evaluation level 138a. At operation 314, the server 102 is configured to train a communication model 160a to perform the sub-operations 143a of the operational path 141a using the static token 164a the dynamic token 165a the tolerances 145a and the configuration parameters 140a. At operation 316, the server 102 is configured to perform a sub-operation 143a out of the sub-operations 143a in accordance with the communication model 160. At operation 318, the server 102 is configured to update the dynamic token 165a to account for modifications 146a (e.g., changes) to the starting data after performing the sub-operation 143a.

At operation 320, the server 102 is configured to determine whether one or more modifications 146a (e.g., changes) in the dynamic token 165g are within a corresponding tolerance 145a. If the server 102 determines that the one or more modifications 146a in the dynamic token 165g are not within the corresponding tolerance 145a (e.g., NO), the process 300 proceeds to operation 322. The process 300 may continue at operations 322-326, where the server 102 is configured to determine an additional operational path 141h. If the server 102 determines that the one or more modifications 146a in the dynamic token 165g are within the corresponding tolerance 145a (e.g., YES), the process 300 proceeds to operation 332.

At operation 322, the server 102 may be configured to determine a communication anomaly 108 associated with the modifications 146a. At operation 322 the server 102 may be configured to determine one or more knowledge base commands 166a configured to fix the communication anomaly 108a. The one or more knowledge base commands 166a may be one or more commands configured to modify tolerances 145a, one or more services 156a involved in the operational path 141a, and/or configuration parameters 140. At operation 326 the server 102 may be configured to update the configuration parameters 140 to account for the one or more knowledge base commands 166a. In some embodiments, the process 300 may continue at operation 306 where the server 102 is configured to execute the one or more ML algorithms 162 to determine an operational path 141b to complete the data exchange operation 104a over a path duration 142b based on an updated version of the configuration parameters 140. In other embodiments, the process 300 may continue at operation 306 where the server 102 is configured to execute the one or more ML algorithms 162 to determine the operational path 141b to complete the data exchange operation 104a over the path duration 142b based on an updated version of the configuration parameters 140. The operational path 141a and the operational path 141b may be at least partially different from one another. In the operational path 141a and the operational path 141b, one or more of the sub-operations 143 may be similar to one another and/or one or more of the operation points 144 may be similar to one another.

The process 300 may end at operation 332, where the server 102 may be configured to perform a sub-operation 143a in accordance with the communication model 160. In some embodiments the server 102 may be configured to train the one or more ML models 160 using one or more reports 168 generated along one or more operations 302-332.

### Scope of the disclosure

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted or not implemented.

In addition, techniques, systems, subsystems, and methods described and illustrated in the various embodiments as discrete or separate may be combined or integrated with other systems modules techniques or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes substitutions and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 1129 (f) as it exists on the date of filing hereof unless the words “means for” or “step for” are explicitly used in the particular claim.

1. An apparatus, comprising:
a memory operable to store:
one or more machine learning algorithms configured to perform one or more operations in accordance with one or more machine learning models; and
at least one processor communicatively coupled to the memory and configured to:
receive a first request to perform a first data exchange operation at a first communication level and a first evaluation level;
determine a first plurality of configuration parameters based on the first data exchange operation, the first plurality of configuration parameters comprising first guidance to perform the first data exchange operation; and
execute the one or more machine learning algorithms to:
determine a first operational path to complete the first data exchange operation over a first path duration based on the first plurality of configuration parameters, wherein:
the first operational path comprises a first plurality of sub-operations to be performed over the first path duration to complete the first data exchange operation; and
the first plurality of sub-operations comprising a first sub-operation and a second sub-operation;
assign a first static token to the first data exchange operation based on the first communication level, the first static token referencing the first plurality of sub-operations to be performed on the first operational path over the first path duration;
assign a first dynamic token to the first data exchange operation based on the first evaluation level, the first dynamic token referencing starting data to be modified by the first plurality of sub-operations on the first operational path over the first path duration;
create a first plurality of tolerances for one or more possible changes to the starting data based on the first communication level and the first evaluation level, wherein the first plurality of tolerances comprises:
a first tolerance corresponding to a first possible change to the starting data at the first sub-operation; and
a second tolerance corresponding to a second possible change to the starting data at the second sub-operation;
train a first communication model to perform the first plurality of sub-operations of the first operational path using the first static token, the first dynamic token, the first plurality of tolerances, and the first plurality of configuration parameters; and
perform one or more of the first plurality of sub-operations in accordance with the first communication model.

2. The apparatus of claim 1, wherein the at least one processor is further configured to:
in conjunction with performing one or more of the first plurality of sub-operations in accordance with the first communication model, perform the first sub-operation;
in response to performing the first sub-operation, update the first dynamic token to reference a first plurality of changes made to the starting data at the first sub-operation;
extract the first plurality of changes made to the starting data at the first sub-operation;
determine whether the first plurality of changes is within the first tolerance of the first plurality of tolerances; and
in response to determining that the first plurality of changes is within the first tolerance of the first plurality of tolerances, perform the second sub-operation.

3. The apparatus of claim 1, wherein the at least one processor is further configured to:
in conjunction with performing one or more of the first plurality of sub-operations in accordance with the first communication model, perform the first sub-operation;
in response to performing the first sub-operation, update the first dynamic token to reference a first plurality of changes made to the starting data at the first sub-operation;
extract the first plurality of changes made to the starting data at the first sub-operation;
determine whether the first plurality of changes is within the first tolerance of the first plurality of tolerances;
in response to determining that the first plurality of changes is not within the first tolerance of the first plurality of tolerances, determine a communication anomaly associated with the first plurality of changes;
determine one or more knowledge base commands configured to fix the communication anomaly;
update the first plurality of configuration parameters to account for the one or more knowledge base commands;
determine a second operational path to perform the first data exchange operation over a second path duration based on an updated version of the first plurality of configuration parameters;
assign a second static token to the first data exchange operation based on the first communication level, the second static token referencing the first plurality of sub-operations to be performed on the second operational path over the second path duration;
assign a second dynamic token to the first data exchange operation based on the first evaluation level, the second dynamic token referencing the starting data to be modified by the first plurality of sub-operations on the second operational path over the second path duration;
train the first communication model to perform the first plurality of sub-operations of the second operational path using the second static token, the second dynamic token, the first plurality of tolerances, and the updated version of the first plurality of configuration parameters; and
perform one or more of the first plurality of sub-operations in accordance with an updated version of the first communication model.

4. The apparatus of claim 3, wherein the at least one processor is further configured to:
use the updated version of the first communication model to train the one or more machine learning models.

5. The apparatus of claim 1, wherein:
the first communication level is an enriched communication level that comprises tracking inputs and outputs associated with the first data exchange operation from an origin point to a completion point in the first operational path.

6. The apparatus of claim 1, wherein:
the first communication level is a granularity communication level that comprises tracking inputs and outputs associated with each of the first plurality of sub-operations at each point in the first operational path.

7. The apparatus of claim 1, wherein:
the first evaluation level is a request level that causes the first dynamic token to reference the starting data to be modified by all of the first plurality of sub-operations.

8. The apparatus of claim 1, wherein:
the first evaluation level is a record level that causes the first dynamic token to reference the starting data to be modified by each of the first plurality of sub-operations.

9. The apparatus of claim 1, wherein:
the first evaluation level is a data-element level that causes the first dynamic token to reference the starting data to be modified by at least one of the first plurality of sub-operations.

10. The apparatus of claim 1, wherein the at least one processor is further configured to:
receive a second request to perform a second data exchange operation at a second communication level and a second evaluation level;
determine a second plurality of configuration parameters based on the second data exchange operation, the second plurality of configuration parameters comprising second guidance to perform the second data exchange operation; and
execute the one or more machine learning algorithms to:
determine a second operational path to complete the second data exchange operation over a second path duration based on the second plurality of configuration parameters, wherein:
the second operational path comprises a second plurality of sub-operations to be performed over the second path duration to complete the second data exchange operation; and
the second plurality of sub-operations comprising a third sub-operation and a fourth sub-operation;
assign a second static token to the second data exchange operation based on the second communication level, the second static token referencing the second plurality of sub-operations to be performed on the second operational path over the second path duration;
assign a second dynamic token to the second data exchange operation based on the second evaluation level, the second dynamic token referencing additional starting data to be modified by the second plurality of sub-operations on the second operational path over the second path duration;
create a second plurality of tolerances for one or more additional possible changes to the additional starting data based on the second communication level and the second evaluation level, wherein the second plurality of tolerances comprises:
a third tolerance corresponding to a third possible change to the additional starting data at the third sub-operation; and
a fourth tolerance corresponding to a fourth possible change to the additional starting data at the fourth sub-operation;
train a second communication model to perform the second plurality of sub-operations of the second operational path using the second static token, the second dynamic token, the second plurality of tolerances, and the second plurality of configuration parameters; and
perform one or more of the second plurality of sub-operations in accordance with the second communication model.

11. A method, comprising:
receiving a first request to perform a first data exchange operation at a first communication level and a first evaluation level;
determining a first plurality of configuration parameters based on the first data exchange operation, the first plurality of configuration parameters comprising first guidance to perform the first data exchange operation; and
executing one or more machine learning algorithms to perform one or more operations comprising:
determining a first operational path to complete the first data exchange operation over a first path duration based on the first plurality of configuration parameters, wherein:
the first operational path comprises a first plurality of sub-operations to be performed over the first path duration to complete the first data exchange operation; and
the first plurality of sub-operations comprising a first sub-operation and a second sub-operation;
assigning a first static token to the first data exchange operation based on the first communication level, the first static token referencing the first plurality of sub-operations to be performed on the first operational path over the first path duration;
assigning a first dynamic token to the first data exchange operation based on the first evaluation level, the first dynamic token referencing starting data to be modified by the first plurality of sub-operations on the first operational path over the first path duration;
creating a first plurality of tolerances for one or more possible changes to the starting data based on the first communication level and the first evaluation level, wherein the first plurality of tolerances comprises:
a first tolerance corresponding to a first possible change to the starting data at the first sub-operation; and
a second tolerance corresponding to a second possible change to the starting data at the second sub-operation;
training a first communication model to perform the first plurality of sub-operations of the first operational path using the first static token, the first dynamic token, the first plurality of tolerances, and the first plurality of configuration parameters; and
performing one or more of the first plurality of sub-operations in accordance with the first communication model.

12. The method of claim 11, further comprising:
in conjunction with performing one or more of the first plurality of sub-operations in accordance with the first communication model, performing the first sub-operation;
in response to performing the first sub-operation, updating the first dynamic token to reference a first plurality of changes made to the starting data at the first sub-operation;
extracting the first plurality of changes made to the starting data at the first sub-operation;
determining whether the first plurality of changes is within the first tolerance of the first plurality of tolerances; and
in response to determining that the first plurality of changes is within the first tolerance of the first plurality of tolerances, performing the second sub-operation.

13. The method of claim 11, further comprising:
in conjunction with performing one or more of the first plurality of sub-operations in accordance with the first communication model, performing the first sub-operation;
in response to performing the first sub-operation, updating the first dynamic token to reference a first plurality of changes made to the starting data at the first sub-operation;
extracting the first plurality of changes made to the starting data at the first sub-operation;
determining whether the first plurality of changes is within the first tolerance of the first plurality of tolerances;
in response to determining that the first plurality of changes is not within the first tolerance of the first plurality of tolerances, determining a communication anomaly associated with the first plurality of changes;
determining one or more knowledge base commands configured to fix the communication anomaly;
updating the first plurality of configuration parameters to account for the one or more knowledge base commands;
determining a second operational path to perform the first data exchange operation over a second path duration based on an updated version of the first plurality of configuration parameters;
assigning a second static token to the first data exchange operation based on the first communication level, the second static token referencing the first plurality of sub-operations to be performed on the second operational path over the second path duration;
assigning a second dynamic token to the first data exchange operation based on the first evaluation level, the second dynamic token referencing the starting data to be modified by the first plurality of sub-operations on the second operational path over the second path duration;
training the first communication model to perform the first plurality of sub-operations of the second operational path using the second static token, the second dynamic token, the first plurality of tolerances, and the updated version of the first plurality of configuration parameters; and
performing one or more of the first plurality of sub-operations in accordance with an updated version of the first communication model.

14. The method of claim 13, further comprising:
using the updated version of the first communication model to train one or more machine learning models.

15. The method of claim 11, wherein:
the first communication level is an enriched communication level that comprises tracking inputs and outputs associated with the first data exchange operation from an origin point to a completion point in the first operational path.

16. A non-transitory computer-readable medium storing instructions that when executed by a processor cause the processor to:
receive a first request to perform a first data exchange operation at a first communication level and a first evaluation level;
determine a first plurality of configuration parameters based on the first data exchange operation, the first plurality of configuration parameters comprising first guidance to perform the first data exchange operation; and
execute one or more machine learning algorithms to:
determine a first operational path to complete the first data exchange operation over a first path duration based on the first plurality of configuration parameters, wherein:
the first operational path comprises a first plurality of sub-operations to be performed over the first path duration to complete the first data exchange operation; and
the first plurality of sub-operations comprising a first sub-operation and a second sub-operation;
assign a first static token to the first data exchange operation based on the first communication level, the first static token referencing the first plurality of sub-operations to be performed on the first operational path over the first path duration;
assign a first dynamic token to the first data exchange operation based on the first evaluation level, the first dynamic token referencing starting data to be modified by the first plurality of sub-operations on the first operational path over the first path duration;
create a first plurality of tolerances for one or more possible changes to the starting data based on the first communication level and the first evaluation level, wherein the first plurality of tolerances comprises:
a first tolerance corresponding to a first possible change to the starting data at the first sub-operation; and
a second tolerance corresponding to a second possible change to the starting data at the second sub-operation;
train a first communication model to perform the first plurality of sub-operations of the first operational path using the first static token, the first dynamic token, the first plurality of tolerances, and the first plurality of configuration parameters; and
perform one or more of the first plurality of sub-operations in accordance with the first communication model.

17. The non-transitory computer-readable medium of claim 16, wherein, when executed by the processor, the instructions further cause the processor to:
in conjunction with performing one or more of the first plurality of sub-operations in accordance with the first communication model, perform the first sub-operation;
in response to performing the first sub-operation, update the first dynamic token to reference a first plurality of changes made to the starting data at the first sub-operation;
extract the first plurality of changes made to the starting data at the first sub-operation;
determine whether the first plurality of changes is within the first tolerance of the first plurality of tolerances; and
in response to determining that the first plurality of changes is within the first tolerance of the first plurality of tolerances, perform the second sub-operation.

18. The non-transitory computer-readable medium of claim 16, wherein, when executed by the processor, the instructions further cause the processor to:
in conjunction with performing one or more of the first plurality of sub-operations in accordance with the first communication model, perform the first sub-operation;
in response to performing the first sub-operation, update the first dynamic token to reference a first plurality of changes made to the starting data at the first sub-operation;
extract the first plurality of changes made to the starting data at the first sub-operation;
determine whether the first plurality of changes is within the first tolerance of the first plurality of tolerances;
in response to determining that the first plurality of changes is not within the first tolerance of the first plurality of tolerances, determine a communication anomaly associated with the first plurality of changes;
determine one or more knowledge base commands configured to fix the communication anomaly;
update the first plurality of configuration parameters to account for the one or more knowledge base commands;
determine a second operational path to perform the first data exchange operation over a second path duration based on an updated version of the first plurality of configuration parameters;
assign a second static token to the first data exchange operation based on the first communication level, the second static token referencing the first plurality of sub-operations to be performed on the second operational path over the second path duration;
assign a second dynamic token to the first data exchange operation based on the first evaluation level, the second dynamic token referencing the starting data to be modified by the first plurality of sub-operations on the second operational path over the second path duration;
train the first communication model to perform the first plurality of sub-operations of the second operational path using the second static token, the second dynamic token, the first plurality of tolerances, and the updated version of the first plurality of configuration parameters; and
perform one or more of the first plurality of sub-operations in accordance with an updated version of the first communication model.

19. The non-transitory computer-readable medium of claim 18, wherein, when executed by the processor, the instructions further cause the processor to:
use the updated version of the first communication model to train one or more machine learning models.

20. The non-transitory computer-readable medium of claim 16, wherein:
the first communication level is an enriched communication level that comprises tracking inputs and outputs associated with the first data exchange operation from an origin point to a completion point in the first operational path.
